(19) United States
(12) Patent Application Publication
(10) Pub. No.: US 2013/0147171 A1
(43) Pub. Date: Jun. 13, 2013

(54) AIRBAG FOR VEHICLE

(71) Applicants: Hyo Shub SHIN, Hwaseong-si (KR); Hyeong Ho Choi, Whasung-Si (KR); Tae In Kim, Whasung-Si (KR); Jung Yeol Jang, Whasung-Si (KR); Jae Haeng Yoo, Whasung-Si (KR)

(72) Inventors: Hyo Shub SHIN, Hwaseong-si (KR); Hyeong Ho Choi, Whasung-Si (KR); Tae In Kim, Whasung-Si (KR); Jung Yeol Jang, Whasung-Si (KR); Jae Haeng Yoo, Whasung-Si (KR)

(73) Assignee: Hyundai Motor Company, Seoul (KR)

(21) Appl. No.: 13/532,551

(22) Filed: Jun. 25, 2012

(30) Foreign Application Priority Data
Dec. 9, 2011 (KR) 10-2011-0131862

(51) Int. Cl. B60R 21/2338

(52) U.S. Cl. 280/743.2

(57) ABSTRACT

An airbag apparatus for a vehicle, may include an integrated vent formed in an airbag cushion, a tube provided on the airbag cushion and communicating with the integrated vent, wherein an inner diameter of the tube varies while gas may be discharged through the tube, so that a rate at which gas may be discharged from the airbag cushion may be adjusted according to a point of time of deployment of the airbag cushion, and a tether wrapped around the tube, the tether being connected to inner surface of the airbag cushion such that opposite ends of the tether may be pulled away from each other when the airbag cushion deploys, so that in a predetermined time period of the deployment of the airbag cushion, the tether contracts the tube, and after the predetermined time period, the tether snaps, thus releasing the tube.

### CROSS-REFERENCE TO RELATED APPLICATIONS

The present application claims priority to Korean Patent Application No. 10-2011-0131862 filed on Dec. 9, 2011, the entire contents of which is incorporated herein for purposes by this reference.

### BACKGROUND OF THE INVENTION

1. Field of the Invention

The present invention relates to an airbag for a vehicle which is configured such that the number of vents formed in an airbag cushion is reduced and a rate at which gas is discharged from the airbag cushion is appropriately controlled, thus reducing the risk of injuring an occupant, and increasing the degree of freedom in design of the airbag cushion.

2. Description of Related Art

Generally, airbag systems are installed in a vehicle to protect occupants in the vehicle from impact during a vehicle collision.

In the airbag system, an airbag cushion is normally installed in an airbag housing in a folded state. In case of a vehicle collision, an inflator rapidly supplies gas into the airbag cushion in response to the sensing of a sensor so that the airbag cushion deploys instantaneously, thus protecting the occupant from impact during the collision.

However, if the pressure in the airbag cushion when deploying is comparatively high in order to reliably reduce the risk of injuring the neck of the occupant, the back of the head of the occupant may be made to strike the headrest of a seat by the instantaneous inflation pressure of the airbag cushion, resulting in the occupant injuring his/her head.

In an effort to overcome the above problem, a technique has been proposed, in which vents are formed on opposite sides of the airbag cushion so that when the airbag cushion deploys, gas is injected into the airbag cushion and discharged early from out of the vents to prevent the airbag cushion from striking the occupant because of an excessively high pressure of inflation.

However, in this conventional airbag cushion, because the vents open even at the initial stage of deployment of the airbag cushion, an excessive pressure loss may be caused during the deployment of the airbag cushion. Thereby, the airbag cushion may not be able to correctly restrain the occupant at the initial stage of the vehicle collision, thus inducing a change in the conditions related to the injury of the occupant.

To solve this problem, as shown in FIG. 1, an airbag has been proposed, in which an active vent 12 is formed in an airbag cushion 10 so that at the initial stage of deployment of the airbag cushion 10, the pressure in the airbag cushion 10 is maintained high so as to rapidly deploy the airbag cushion 10, and after the point of time at which the weight of the occupant is applied to the airbag cushion 10, gas is discharged from the airbag cushion 10 through the active vent 12, as well as through a basic vent 11, so as to rapidly reduce the pressure in the airbag cushion 10.

Furthermore, an LRD (Low Risk Deployment) vent 13 is further formed in the airbag cushion 10. Thus, as shown in FIG. 2, even if a person of small stature, for example, a child, sits on a passenger seat, gas is discharged from the airbag cushion through the basic vent 11 and the LRD vent 13, thus preventing the deployment of the airbag cushion from injuring the occupant.

However, in this conventional technique, the number of vents through which gas is discharged from the airbag cushion is increased, thus excessively increasing a rate at which gas is discharged from the airbag cushion. Therefore, the pressure in the airbag cushion decreases excessively rapidly, and the volume with which the airbag cushion deploys is reduced, thus increasing the risk of injuring the occupant.

In addition, the structure having the increased number of vents in the airbag cushion makes the internal shape of the airbag cushion complex, resulting in increasing the production cost of the airbag cushion, and reducing the degree of freedom in the shape of the airbag cushion, thereby making the design of the airbag cushion difficult.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an airbag for a vehicle which is configured such that the number of vents formed in an airbag cushion is reduced and a rate at which gas is discharged from the airbag cushion is appropriately controlled, thus reducing the risk of injuring an occupant, and increasing the degree of freedom in the design of the airbag cushion.

In an aspect of the present invention, an airbag apparatus for a vehicle may include an integrated vent formed in an airbag cushion, a tube provided on the airbag cushion and communicating with the integrated vent, wherein an inner diameter of the tube varies while gas is discharged through the tube, so that a rate at which gas is discharged from the airbag cushion is adjusted according to a point of time of deployment of the airbag cushion, and a tether wrapped around the tube, the tether being connected to inner surface of the airbag cushion such that opposite ends of the tether are pulled away from each other when the airbag cushion deploys, so that in a predetermined time period of the deployment of the airbag cushion, the tether contracts the tube, and after the predetermined time period, the tether snaps, thus releasing the tube.

The tether is sewed around the tube.

The airbag apparatus may include a tether cutter provided adjacent to a portion of the tether, the tether cutter cutting the tether after the predetermined time period of the deployment of the airbag cushion.

The tether may include a portion more fragile than other portion thereof so that the tether snaps at the fragile portion due to a predetermined deployment pressure of the airbag cushion.

In the predetermined time period, the tube contracts by the tether in an open state in such a way that the inner diameter of the tube is reduced, thus reducing the rate at which the gas is discharged from the airbag cushion through the tube.

A distal end of the tether is disposed in a lower portion of the airbag cushion when the airbag cushion deploys.

The inner diameter of the tube is shaped to be gradually reduced towards an end of the tube that is connected to the tether to form a truncated cone.

The tube may include a plurality of tubes provided facing each other.

The tube may include a plurality of tubes provided symmetrical each other.

The tube may comprise a plurality of tubes provided symmetrical each other.

In the present invention, a tube connected to an integrated vent is contracted by or released from a tether so that the inner diameter of the tube is controlled according to a point of time of deployment of an airbag cushion. Therefore, at the initial stage of the deployment of the airbag cushion, the inner diameter of the tube is reduced so that the pressure in the airbag cushion is maintained high. Thus, the airbag cushion can rapidly deploy and protect the occupant. At the point of time at which the weight of the occupant is applied to the airbag cushion, the inner diameter of the tube increases so that the gas is rapidly discharged out of the airbag cushion, thus rapidly reducing the pressure in the airbag cushion, thereby effectively reducing the risk of the deployment of the airbag cushion injuring the occupant.

Moreover, the number of vents through which gas is discharged from the airbag cushion is reduced, thus reducing the rate at which gas is discharged from the airbag cushion while it is deploying, thereby increasing the pressure in the airbag cushion and the volume with which the airbag cushion deploys. Hence, the present invention can reduce the risk of injuring the occupant.

Furthermore, the structure having the reduced number of vents makes the internal structure of the airbag cushion simple. Consequently, the production cost of the airbag cushion can be reduced, and the shape of the airbag cushion can be easily designed without restricting the design attributable to the vents.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is of views illustrating deployment of a conventional airbag for a vehicle.

FIG. 2 is a view showing the function of an LRD vent of the conventional airbag.

FIG. 3 is of views illustrating deployment of an airbag for a vehicle, according to an exemplary embodiment of the present invention.

FIG. 4 is of plan views of the airbag of FIG. 3.

FIG. 5 is of views showing a process of contracting a tube using a tether and releasing the tube therefrom during the deployment of the airbag according to an exemplary embodiment of the present invention.

FIG. 6 is a view illustrating deployment of the airbag when an occupant is a child, according to an exemplary embodiment of the present invention.

FIG. 7 is a plan view of the airbag of FIG. 6.

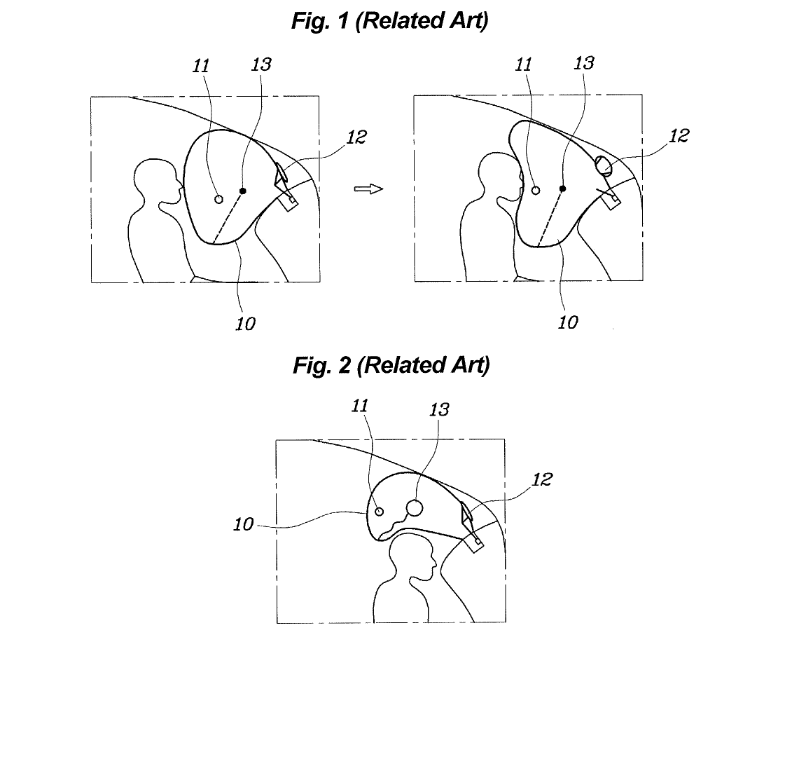

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, an embodiment of the present invention will be described in detail with reference to the attached drawings.

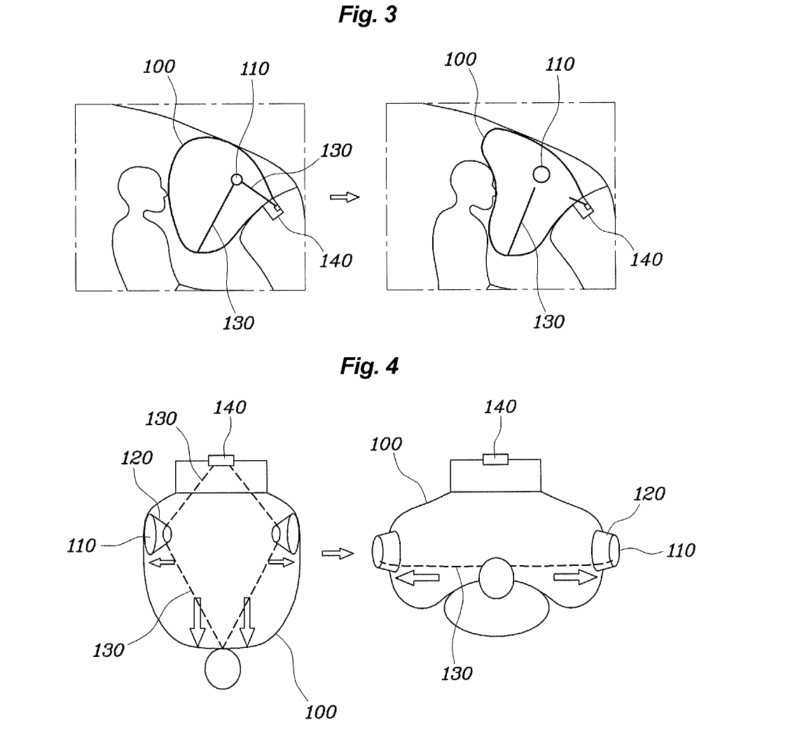

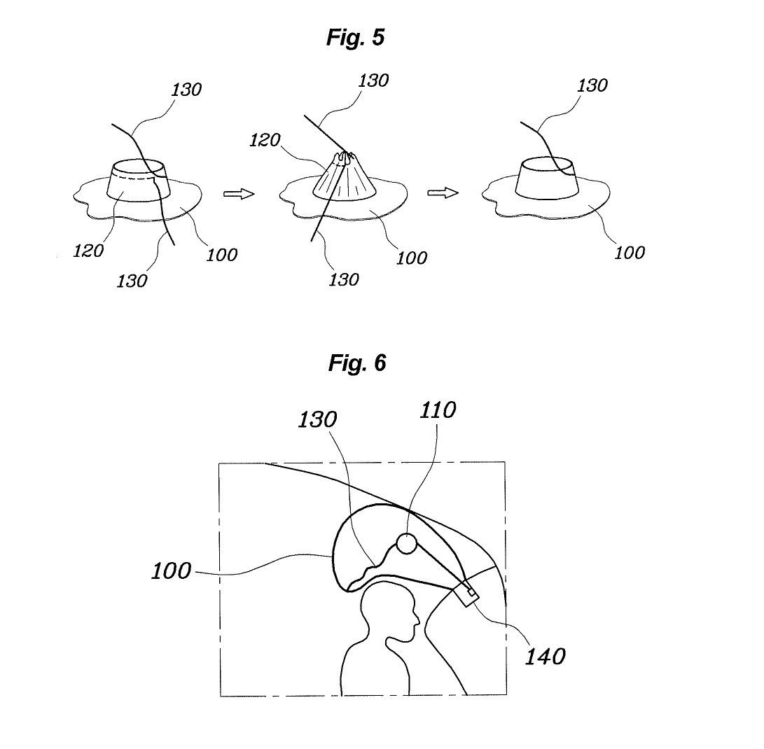

As shown in FIGS. 3 through 7, an airbag for a vehicle according to an exemplary embodiment of the present invention includes an integrated vent 110, a tube 120 and a tether 130. The integrated vent 110 is formed in an airbag cushion 100. The tube 120 is provided on the airbag cushion 100 and communicates with the integrated vent 110. The tube 120 is configured such that inner diameter thereof varies while gas is discharged through the tube 120, so that the rate at which gas is discharged from the airbag cushion 100 is adjusted according to a point of time in the deployment of the airbag cushion 100. The tether 130 is wrapped around the tube 120, and opposite ends of the tether 130 are connected to the airbag cushion 100. In an exemplary embodiment of the present invention, the tether 130 is sewn around the tube 120 as shown in FIG. 5.

At an initial stage of the deployment of the airbag cushion 100, the tether 130 contracts the tube 120. When the pressure in the airbag cushion 100 exceeds a predetermined threshold, the tether 130 snaps, releasing the tube 120.

That is, unlike the conventional technique having the vents that discharge gas from the airbag cushion, the present invention is designed such that the vents are integrated into the signal integrated vent 110, and the inner diameter of the tube 120 that communicates with the integrated vent 110 is adjusted by the tether 130 according to the point of time in the deployment of the airbag cushion 100.

In detail, at the initial stage of the deployment of the airbag cushion 100, tensile force is applied to the tether 130, thus contracting the tube 120. Then, the inner diameter of the tube 120 shrinks, thus reducing the rate at which gas is discharged from the airbag cushion 100. Thereby, the pressure in the airbag cushion 100 increases so that the airbag cushion 100 can rapidly deploy.

Thereafter, at the point of time at which an occupant comes into contact with the airbag cushion 100, a portion of the tether 130 that is adjacent to an airbag housing snaps, and the tether 130 which has contracted the tube 120 is loosened. As a result, the inner diameter of the tube 120 becomes largest, thus increasing the gas discharge rate, thereby reducing the pressure in the airbag cushion 100. Eventually, the airbag cushion 100 can safely and reliably restrain and support the body of the occupant.

The present invention may further include a tether cutter 140 which is provided adjacent to one end of the tether 130 and cuts the tether 130 after the initial stage of the deployment of the airbag cushion 100.

In other words, the snapping of the tether 130 is realized by the tether cutter 140. After the initial stage of the deployment of the airbag cushion 100, a large amount of air can be discharged through the tube 120 for the time for which the airbag cushion 100 supports the body of the occupant. Thus, the airbag cushion 100 can more effectively absorb and mitigate the load imposed by the occupant. The snapping of the tether 130 may be realized by different methods, as well as, using the tether cutter 140. For instance, a fragile portion may be formed in the tether 130 so that the tether 130 snaps at the fragile portion due to the pressure at which the airbag cushion 100 deploys. That is, in this case, the tether 130 can snap by itself.

In an exemplary embodiment of the present invention, the tube 120 contracts in the open state, thus reducing the gas discharge rate.

As such, at the initial stage of the deployment of the airbag cushion 100, as the airbag cushion 100 deploys, the tether 130 acts as if the opposite ends thereof had been pulled. The tether 130 thus contracts the end of the tube 120. With regard to the degree with which the tube 120 contracts, the tube 120 is contracted such that the tube 120 opens only half of that of the completely open state, thus reducing the rate at which gas is discharged through the tube 120.

Therefore, at the initial stage of the deployment of the airbag cushion 100, not only can the airbag cushion 100 rapidly deploy but the volume thereof can also become sufficiently large. Therefore, the airbag cushion 100 can reliably support and absorb the weight of the occupant.

The present invention may be configured such that one end of the tether 130 is disposed in a lower portion of the airbag cushion 100 while the airbag cushion 100 is deploying.

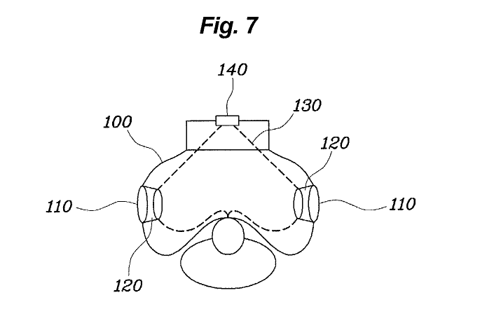

In detail, as shown in FIGS. 6 and 7, if a person of small stature, for example, a child, sits on the seat, when the airbag cushion 100 deploys, the top portion of the head of the child pushes the lower portion of the airbag cushion 100 so that the airbag cushion 100 cannot completely deploy downwards.

Hence, in the configuration in which the one end of the tether 130 is connected to the lower portion of the airbag cushion 100, the opposite ends of the tether 130 cannot be pulled so that the tether 130 is maintained loosely. Thereby, the tube 120 is not contracted, and the inner diameter of the tube 120 is maintained in the completely open state.

Therefore, the rate at which gas is discharged from the airbag cushion 100 through the tube 120 is increased, so that the volume of the deploying airbag cushion 100 is reduced. Eventually, the child can be reliably protected from the airbag cushion 100 deploying at high pressure and high speed.

As shown in FIGS. 4 and 5, the tube 120 is configured such that the inner diameter thereof is gradually reduced towards the end of the tube 120 that is connected to the tether 130.

In detail, as the airbag cushion 100 deploys, the tube 120 deploys out of the airbag cushion 100 while gas is discharged through the tube 120. Here, the tube 120 is configured such that the inner diameter thereof is gradually reduced towards the outer end of the tube 120 when has deployed outwards. Therefore, the rate at which gas is discharged out of the airbag cushion 100 can be appropriately controlled, rather than gas being excessively rapidly discharged out of the airbag cushion 100.

In an exemplary embodiment of the present invention, the tube 120 may include a plurality of tubes 120 and be disposed to face each other. That is, the tubes 120 are provided on respective opposite sides of the airbag cushion 100. It is preferable the tubes 120 be provided facing each other and be oriented at the same angle on the same axis.

The configuration of the tubes 120 facing each other is not limited to that mentioned above. In addition to that of the exemplary embodiment, the tubes 120 that face each other may be provided on opposite sides and be oriented in the opposite directions at the same angle on the same axis.

For example, the tubes 120 may be configured such that one tube 120 is angled upwards while the other tube 120 is angled downwards.

In an exemplary embodiment of the present invention, the tubes 120 may be provided such that they are symmetric with each other. In other words, the tubes 120 that are provided on opposite sides of the airbag cushion 100 may be disposed on the same axis and be vertically symmetrical with each other.

The symmetric structure of the tubes 120 is not limited to that mentioned above. In addition to this, the tubes 120 that are provided on opposite sides of the airbag cushion 100 may be disposed on the same axis and angled at the same angle in the same direction so that the opposite tubes 120 are vertically symmetrical with each other.

For example, the tubes 120 may be configured such that one tube 120 is angled upwards while the other tube 120 is also angled upwards.

The operation and effect of the present invention will be described in detail with reference to FIGS. 3 and 4.

In a vehicle collision, gas is injected into the airbag cushion 100 by an inflator that is provided in an airbag module. As the airbag cushion 100 deploys, tensile force is applied to the tether 130 connected to the tube 120 that protrudes into the airbag cushion 100, as if the opposite ends of the tether 130 had been pulled.

Therefore, at the initial stage of the deployment of the airbag cushion 100, the tether 130 contracts the open end of the tube 120, reducing the rate at which gas is discharged out of the airbag cushion 100 through the tube 120. Thus, the pressure in the airbag cushion 100 rapidly increases so that not only can the airbag cushion 100 rapidly deploy but the volume thereof can also become sufficiently large. Consequently, the airbag cushion 100 can rapidly form a predetermined shape that can reliably support the weight of the occupant.

Subsequently, in the process of the airbag cushion 100 completely deploying, one end of the tether 130 is cut by the tether cutter 140. Here, the tether 130 may automatically snap due to the pressure of gas that is rapidly injected into and inflates the airbag cushion 100.

As such, upon the snapping of the tether 130, the tensile force of the tether 130 which has contracted the tube 120 is removed, thus releasing the tube 120. Then, the pressure of gas that is rapidly supplied into the airbag cushion 100 protrudes and deploys the tube 120 out of the integrated vent 110, thus completely opening the tube 120. Hence, the gas which has been in the airbag cushion 100 is rapidly discharged to the outside through the tube 120.

At the point of time after which the gas is discharged to the outside, the body of the occupant comes into contact with the airbag cushion 100, and the airbag cushion 100 begins to support the weight of the occupant, thus effectively reducing the risk of the deployment of the airbag cushion 100 injuring the occupant.

As such, in an exemplary embodiment of the present invention, the tube 120 connected to the integrated vent 110 is contracted by or released from the tether 130 so that the inner diameter of the tube 120 can be controlled, depending on the point of time of deployment of the airbag cushion 100.

Therefore, at the initial stage of the deployment of the airbag cushion 100, the inner diameter of the tube 120 reduces so that the pressure in the airbag cushion 100 is maintained high. Thus, the airbag cushion 100 can rapidly deploy and protect the occupant. At the point of time at which the weight of the occupant is applied to the airbag cushion, the inner diameter of the tube 120 increases so that the gas is rapidly discharged out of the airbag cushion 100, thus rapidly reducing the pressure in the airbag cushion 100, thereby effectively reducing the risk of the deployment of the airbag cushion 100 injuring the occupant.

Moreover, the present invention is designed such that the vents are integrated into the signal integrated vent 110. Hence, at the initial stage of the deployment of the airbag cushion 100, the rate at which gas is discharged out of the airbag cushion 100 can be reliably reduced, thus sufficiently increasing the pressure in the airbag cushion 100, and making the volume of the airbag cushion 100 larger. Thereby, the present invention can reduce the risk of injury of the occupant, particularly, markedly reducing the risk of injury of the neck.

Furthermore, because the present invention is designed such that the vents which have been formed in the airbag cushion in the conventional technique are integrated into the signal integrated vent 110, the internal structure of the airbag cushion 100 is simplified, thus solving the conventional problem of interference between the vents and the tether which the design of the airbag cushion had to take into consideration. Consequently, the production cost of the airbag cushion 100 can be reduced, and the shape of the airbag cushion 100 can be easily designed without restricting the design attributable to the vents.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An airbag apparatus for a vehicle, comprising:
an integrated vent formed in an airbag cushion;
a tube provided on the airbag cushion and communicating with the integrated vent, wherein an inner diameter of the tube varies while gas is discharged through the tube, so that a rate at which gas is discharged from the airbag cushion is adjusted according to a point of time of deployment of the airbag cushion; and
a tether wrapped around the tube, the tether being connected to inner surface of the airbag cushion such that opposite ends of the tether are pulled away from each other when the airbag cushion deploys, so that in a predetermined time period of the deployment of the airbag cushion, the tether contracts the tube, and after the predetermined time period, the tether snaps, thus releasing the tube.

2. The airbag apparatus as set forth in claim 1, wherein the tether is sewed around the tube.

3. The airbag apparatus as set forth in claim 1, further including a tether cutter provided adjacent to a portion of the tether, the tether cutter cutting the tether after the predetermined time period of the deployment of the airbag cushion.

4. The airbag apparatus as set forth in claim 1, wherein the tether include a portion more fragile than other portion thereof so that the tether snaps at the fragile portion due to a predetermined deployment pressure of the airbag cushion.

5. The airbag apparatus as set forth in claim 1, wherein in the predetermined time period, the tube contracts by the tether in an open state in such a way that the inner diameter of the tube is reduced, thus reducing the rate at which the gas is discharged from the airbag cushion through the tube.

6. The airbag apparatus as set forth in claim 1, wherein a distal end of the tether is disposed in a lower portion of the airbag cushion when the airbag cushion deploys.

7. The airbag apparatus as set forth in claim 1, wherein the inner diameter of the tube is shaped to be gradually reduced towards an end of the tube that is connected to the tether to form a truncated cone.

8. The airbag apparatus as set forth in claim 1, wherein the tube includes a plurality of tubes provided facing each other.

9. The airbag apparatus as set forth in claim 1, wherein the tube includes a plurality of tubes provided symmetrical each other.
